(19) United States
(12) Patent Application Publication
(10) Pub. No.: US 2006/0024486 A1
(43) Pub. Date: Feb. 2, 2006

(54) Non-woven protective garments with thermo-regulating properties

(76) Inventor: Barbara Hildegard Pause, Longmont, CO (US)

Correspondence Address: Barbara Pause, 7161 Christopher Court, Longmont, CO, 80503, US

(21) Appl. No.: 10/527,010

(22) PCT Filed: Sep. 9, 2003
(86) PCT No.: PCT/US03/28203

§ 371 Date: Mar. 7, 2005

Related U.S. Application Data
(60) Provisional application No. 60/410,455, filed on Sep. 12, 2002.

(51) Int. Cl. B32B 15/02; B32B 5/14; B32B 27/12; B32B 9/00; B32B 17/02

(52) U.S. Cl. 428/310.5; 442/327; 442/394; 428/402; 428/318.4; 442/381; 442/74

(57) ABSTRACT

Non-woven protective garments consisting of multi-layer composite barrier fabrics where at least one of the layers is made of an elastomeric material comprising finely divided phase change materials such as crystalline alkyl hydrocarbons or salt hydrates facilitate thermo-regulation due to latent heat absorption and latent heat release in the phase transition range of the phase change material, which improves the thermal performance and enhances the comfort of non-woven protective garments significantly.

### CROSS-REFERENCES TO RELATED APPLICATIONS

This application claims priority of U.S. provisional application Ser. No. 60/410,455 filed Sep. 12, 2002 entitled “Nonwoven protective garments with thermo-regulating properties”. The international application Serial No. PCT/US03/28203 entitled “Non-woven protective garments with thermo-regulating properties” was filed Sep. 9, 2003 and published Mar. 25, 2004.

### BACKGROUND OF THE INVENTION

Non-woven protective garments are used in a variety of applications such as asbestos abatement, pest control, transportation of hazardous chemical goods, and cleaning chemical facilities and contaminated soil areas. The construction of the non-woven materials used in such garments provides a high barrier function against the penetration by dust, liquids or gases. However, in the same way the fabric system prevents the transfer of hazardous materials into the garment, it also limits the outward passage of body heat and moisture. As a result, under strenuous activities and moderate to hot climatic conditions, the core temperature of the wearer's body may rise above the comfort level into the heat stress zone. These heat stress conditions lead to discomfort and fatigue and, in severe cases, risk the health and safety of the garment's wearer. However, in cold weather conditions the low moisture transfer can result in body chill of the wearer. Overall, constant discomfort while wearing such protective suits can lead to a reduced productivity and the likelihood of accidents.

A very expensive solution of the problem nowadays is the use of a bulky and heavy microclimate cooling system. However, a much cheaper and durable solution would be the application of phase change material.

Phase change material is a highly-productive thermal storage medium which possesses the ability to change its physical state within a certain temperature range. When the melting temperature is obtained during a heating process, the phase change from the solid to the liquid state occurs. During this melting process, the phase change material absorbs and stores a large amount of latent heat. The temperature of the phase change material remains nearly constant during the entire process. In a cooling process of the phase change material, the stored heat is released into the environment in a certain temperature range, and a reverse phase change from the liquid to the solid state takes place. During this crystallization process, the temperature of the phase change material also remains constant. The high heat transfer during the melting process and the crystallization process, both without any temperature change, is responsible for the phase change material's appeal as a source of heat storage.

In order to contrast the amount of latent heat absorbed by a phase change material during the actual phase change with the amount of sensible heat in an ordinary heating process, the ice-water phase change process will be used. When ice melts, it absorbs an amount of latent heat of about 335 J/g. When the water is further heated, it absorbs a sensible heat of only 4 J/g while its temperature rises by one degree C. Therefore, the latent heat absorption during the phase change from ice into water is nearly 100 times higher than the sensible heat absorption during the heating process of water outside the phase change temperature range.

In addition to ice (water), more than 500 natural and synthetic phase change materials are known. These materials differ from one another in their phase change temperature ranges and their heat storage capacities.

Currently, only crystalline alkyl hydrocarbon phase change materials having different chain lengths are used in textile applications and more specifically in garment applications. Characteristics of these phase change materials are summarized in Table 1.

TABLE 1
Crystalline alkyl hydrocarbons

| | | | | Latent heat |
|---|---|---|---|---|
| Crystalline | | Melting | Crystallization | storage |
| alkyl | | temperature, | temperature, | capacity, |
| hydrocarbons | Formula | ° C. | ° C. | J/g |
| Heneicosane | C₂₁H₄₄ | 40.5 | 35.9 | 213 |
| Eicosane | C₂₀H₄₂ | 36.1 | 30.6 | 247 |
| Nonadecane | C₁₉H₄₀ | 32.1 | 26.4 | 222 |
| Octadecane | C₁₈H₃₈ | 28.2 | 25.4 | 244 |
| Heptadecane | C₁₇H₃₆ | 21.7 | 16.5 | 213 |
| Hexadecane | C₁₆H₃₄ | 16.7 | 12.2 | 237 |

The crystalline alkyl hydrocarbons are either used in technical grades with a purity of approximately 95% or they are blended with one another in order to cover specific phase change temperature ranges. The crystalline alkyl hydrocarbons are nontoxic, non-corrosive, and non-hygroscopic. The thermal behavior of these phase change materials remains stable under permanent use. Crystalline alkyl hydrocarbons are byproducts of petroleum refining and, therefore, inexpensive.

Salt hydrates are alloys of inorganic salts and water. The most attractive properties of salt hydrates are the comparatively high latent heat storage capacities, the high thermal conductivities and the small volume change during melting. Salt hydrates often show an incongruent melting behaviour as a result of a lack in reversible melting and freezing making them unsuitable for permanent use. Salt hydrates with reversible melting and freezing characteristics are summarized in Table 2.

TABLE 2
Salt hydrates

| | | Latent |
|---|---|---|
| | Melting | heat storage |
| | temperature, | capacity, |
| Salt hydrates | ° C. | J/g |
| Calcium Cloride Hexahydrate | 29.4 | 170 |
| Lithium Nitrate Trihydrate | 29.9 | 236 |
| Sodium Sulfate Decahydrate | 32.4 | 253 |

In the present applications of the phase change material technology in textiles, the crystalline alkyl hydrocarbon are microencapsulated, i.e., contained in small micro-spheres with diameters between I micron and 30 microns. These microcapsules with enclosed phase change material are applied to a textile matrix by incorporating them into acrylic fibers and polyurethane foams or by embedding them into a coating compound and coating them onto textile surfaces.

U.S. Pat. No. 4,756,958 reports a fiber with integral micro-spheres filled with phase change material which has enhanced thermal properties at predetermined temperatures.

U.S. Pat. No. 5,366,801 describes a coating where micro-spheres filled with phase change material are incorporated into a coating compound which is then topically applied to fabric in order to enhance the thermal characteristics thereof.

U.S. Pat. No. 5,637,389 reports an insulating foam with improved thermal performance, wherein micro-spheres filled with phase change material are embedded.

The micro-encapsulation process of crystalline alkyl hydrocarbon phase change materials is a very time-consuming and complicated chemical process running over several stages making the microcapsules with enclosed phase change material very expensive.

In addition to the micro-encapsulation of phase change material, several attempts have been made to contain crystalline alkyl hydrocarbons in certain macro-structures such as a silica powder, or a polyolefin matrix.

U.S. Pat. No. 5,106,520 describes a dry silica powder comprising phase change material.

U.S. Pat. No. 5,053,446 reports a polyolefin composition containing a phase change material and possesses enhanced thermal storage properties.

However, applications of these containment structures have shown that they are not providing a durable containment and the phase change material often disappears while in its liquid stage.

There are several thermal effects which can be obtained by a phase change material application in a certain product, such as:
A cooling effect, caused by heat absorption of the phase change material.
A heating effect, caused by heat emission of the phase change material.
A thermo-regulating effect, resulting from either heat absorption or heat emission of the phase change material.

The efficiency of each of these effects is determined by the latent heat storage capacity of the phase change material, the phase change temperature range and the structure of the carrier system.

The total latent heat storage capacity of the phase change material in a certain product depends on the phase change material's specific latent heat storage capacity and its quantity. In order to obtain a successful phase change material application, the phase change temperature range and the application temperature range need to correspond.

In addition, performance tests carried out on textiles with phase change material have shown that the textile substrate construction also influences the efficiency of the thermal effects obtained by the phase change material. For instance, thinner textiles with higher densities readily support the cooling process.

The purpose of non-woven protective garments is to isolate the wearer's body from direct contact with hazardous materials. In order to fulfil this requirement non-woven protective suits often consist of a multi-layer system of barrier fabrics bonded to each other by lamination.

U.S. Pat. No. No. 4,855,178 describes a composite chemical barrier fabric there a base sheet of non-woven polypropylene is laminated on one side to a multi-layer film sheet comprising of a film of ethylene vinyl alcohol sandwiched between films of nylon with a surface film of linear low-density polyethylene.

Non-woven protective garments are usually manufactured in form of an overall with an integral hood and a visor attached to it which covers the whole body including a self-contained breathing apparatus used in conjunction with it. Under the non-woven protective suit, the workers normally wear an underwear and sometimes a normal work suit.

The work load under which non-woven protective suits are normally worn is moderate to heavy. Metabolic heat rates generated by the human body during these activities are ranging from 15 kJ/min. up to 20 kJ/min. The non-woven protective suits are worn under high and low ambient temperatures. The average wearing time lasts about one to two hours.

### SUMMARY OF THE INVENTION

The invention pertains to non-woven protective garments consisting of a multi-layer composite barrier fabrics wherein at least one of the layers contain finely divided phase change materials such as crystalline alkyl hydrocarbons or salt hydrates. By either latent heat absorption or latent heat emission, the phase change material provides a thermo-regulating system which enhances the thermal performance of the non-woven protective garment substantially.

As one embodiment of the invention finely divided phase change material is incorporated into a film made of silicone rubber which is then laminated to the inner side of the multi-layer barrier fabric the non-woven protective garment consists of. The phase change material incorporated into the silicone rubber provides a latent heat absorption in a temperature range between 25° C. und 35° C. and possesses a high latent heat storage capacity of about 40 kJ to 60 kJ.

### BRIEF DESCRIPTION OF THE DRAWINGS

FIG. 1 is a sectional view of a non-woven protective garment consisting of a two-layer composition where phase change material is incorporated into one of the layers.

FIG. 2 is a sectional view of a non-woven protective garment consisting of a three-layer composition where phase change material is incorporated into one of the layers.

FIG. 3 is a sectional view of a non-woven protective garment consisting of a four-layer composition where phase change material is incorporated into one of the layers.

FIG. 4 is a sectional view of a non-woven protective garment consisting of a four-layer composition where phase change material is incorporated into one of the layers.

FIG. 5 is a sectional view of a non-woven protective garment consisting of a five-layer composition where phase change material is incorporated into one of the layers.

FIG. 6 is a sectional view of a non-woven protective garment consisting of a five-layer composition where phase change material is incorporated into two of the layers.

FIG. 7 is a graphical representation of the temperature development in the microclimate while wearing a non-woven protective garment with and without phase change material.

FIG. 8 is a graphical representation of the moisture development in the microclimate while wearing a non-woven protective garment with and without phase change material.

### DETAILED DESCRIPTION OF THE INVENTION

It has been discovered that crystalline alkyl hydrocarbons and salt hydrates can be durably contained in an elastomer whereby the phase change materials are cross-linked into the elastomer's structure. For this purpose, the phase change material does not need to be microencapsulated. Finely-divided phase change materials emulsified or dispersed in the elastomer's structure do not flow out of the elastomer structure while in a liquid stage. The composition remains stable under substantial temperature variation over a long service time.

Such elastomeric materials can comprise, by way of example and not by limitation silicone rubber, acrylate rubber, butyl rubber, nitrile rubber or chloroprene rubber.

In order to describe the process in which phase change materials such as crystalline alkyl hydrocarbons and salt hydrates can be durably contained in an elastomeric structure silicone rubber shall be used as an example.

There are several methods that can be applied in order to produce silicone rubber. For containing phase change material inside the silicone rubber matrix, the most appropriate method uses liquid silicone rubbers. Liquid silicone rubbers are paste-like flow-able, two-component blends. Liquid silicone rubbers possess a lower viscosity than solid rubbers which especially supports forming the product into a desired shape. Phase change materials (available in a liquid form after melting) can be easily mixed into the two liquid components the basic silicone rubber components consist of.

Liquid silicon rubbers are available in different versions. Some of the standard types provide an exceptional mechanical strength and elasticity. There are liquid silicone rubbers available which cure in a very short period of times. Another liquid silicone rubber system possesses a very high flame resistance. They are all supplied ready for processing. One of the two components contains, for instance, a platinum catalyst and the other component a hydrogen-functional polysiloxane cross-linking agent.

The crystalline alkyl hydrocarbons or the salt hydrates create a third component which needs to be mixed into the system while they are in a liquid stage. The crystalline alkyl hydrocarbons or the salt hydrates may be incorporated into the silicone rubber matrix in a weight portion of up to 60 wt. % based on the material's total weight. Preferably, the phase change materials are incorporated into the silicone rubber matrix in portions of 30 wt. % to 50 wt. %. These quantities of phase change material ensure a substantial increase in thermal performance. On the other side, the desired mechanical strength, flexibility and durability characteristics of the silicone rubber material can also be maintained. The hardness could be decreased, if necessary, by further adding silicone fluid.

All the components are usually transferred by a metering pump from the containers into the metering cylinder of an injection molding machine. The curing process of the silicone rubber with incorporated phase change material takes place in a container wherein the mixed components are poured by injection molding. Through a calendaring procedure which follows the injection moulding process, the silicone rubber with the incorporated phase change material can be compressed into a thin film which is then laminated to a textile substrate. Another possibility consists in coating the silicon rubber with incorporated phase change material onto a textile or another material where the silicone rubber is then cured. The rate of curing depends on the temperature. The higher the temperature, the faster the curing process will be performed. In order to avoid a water separation and evaporation of the water component of salt hydrates, silicone rubber with incorporated salt hydrates should be cured at temperatures below 80° C. Preferable, most silicone rubber systems with incorporated phase change materials shall be cured at room temperature or at a higher temperature of up to 75° C. Addition-curing components do not release any by-products that have to be removed by any form of after-treatment or post-curing. When bonding the silicon rubber material with incorporated phase change material to a material with a plain surface, a primer should be used ahead to achieve a sufficient adhesion between the silicone rubber material and the carrier material.

The silicone rubber made of the described components possesses a very high resistance against the penetration of particles, liquid or gases. In this way, adding a film made of silicone rubber with incorporated phase change material to a non-woven protective garment will increase its barrier function against the penetration of hazardous materials. Silicone rubber is thermally stable in a temperature range between −50° C. and 200° C. Furthermore, the material shows favourable strength characteristics, flexibility and durability.

In their application in non-woven protective garments, the main function of the phase change material will be the absorption of excessive heat generated by the wearer's body while performing strenuous activities under moderate or high ambient temperatures. The heat absorption by the phase change material will keep the microclimate temperature in the comfort range over an extended period of time preventing a higher amount of sweat from being produced by the skin. On the other side, under low ambient temperatures, the heat release by the phase change material will prevent the problem of body chill.

In order to obtain a durable and efficient thermo-regulating effect by the application of phase change material in non-woven protective garments the phase change material needs to be carefully selected and applied in an sufficient quantity. Based on the heat transfer through the complete garment system (underwear, work suit and non-woven protective suit), a suitable phase change material has been selected. The phase change material should absorb latent heat preferably in a temperature range between 25° C. and 35° C. For calculating the required latent heat storage capacity of the phase change material applied to the non-woven protective garment the different physical activities while wearing the non-woven protective suit over various periods of time and under different ambient temperatures have been considered. The necessary heat storage capacity has been determined based on the amount of heat which is generated by the human body during the various physical activities and the amount of heat which penetrates through the garment. The results indicate that an overall latent heat storage capacity of about 40 kJ to 60 kJ is necessary for a complete non-woven protective suit in order to provide the desired thermo-regulating effect and in order to avoid heat stress over a given period.

The crystalline alkyl hydrocarbons or the salt hydrates applied to the multi-layer barrier fabric used for non-woven protective garments possess latent heat storage capacities between 200 J/g and 250 J/g. These phase change materials are applied to the elastomeric matrix, for instance, the silicone rubber preferable in contents of 40 wt. % to 60 wt. %.

Non-woven protective garments consist of two to five layer composite fabrics comprising non-woven, flexible, reinforcing fabric substrates (1) to which barrier films (2) are laminated by thermoplastic polymeric adhesives. The fabric substrates are made, for instance, of spun-bonded polyethylene, spun-bonded polypropylene or aramid non-woven materials. The non-woven fabric substrates provide the required mechanical stability, i.e., the strength and durability of the fabric system. The non-woven fabric substrates already possess a low permeability. However, the impermeable barrier films are responsible for the protective function of the garment. They consist, for instance, of polytetrafluoroethylene (PTFE), nylon, ethylene vinyl alcohol or chlorinated ethylene. In some non-woven protective garment constructions spun laced or melt blown non-woven fabrics are used to provide the barrier effect.

In their construction, the barrier films are laminated to one or two sides of a non-woven fabric substrate. One to two layers of the non-woven fabric substrate and one to three barrier films are combined in such sandwich compositions. Most preferable, the elastomeric material with the directly incorporated phase change material is arranged to the most inner side of multi-layer barrier fabric facing to the wearer's body. In a preferred embodiment, the elastomeric material with incorporated phase change material will be laminated or coated to the inside of the most inner non-woven fabric substrate or the most inner barrier film the non-woven protective garment consists of. Beside applying an additional layer to an already existing composite barrier fabric another embodiment of the present invention is the replacement of the most inner barrier film by the elastomeric film with phase change material. This arrangement will not change the protective function of the composite barrier fabric, because the elastomeric film also provides a barrier function against the penetration of hazardous materials.

FIG. 1 to FIG. 5 show the different arrangements of the elastomeric material with the directly incorporated phase change material in a non-woven protective garment system.

FIG. 1 illustrates a two-layer arrangement where the elastomeric material with incorporated phase change material (3) is attached to a single layer non-woven fabric substrate (1) the non-woven protective garment may consist of. Another embodiment of the arrangement shown in FIG. 1 is the replacement of a barrier film (2) by the elastomeric material with incorporated phase change material (3).

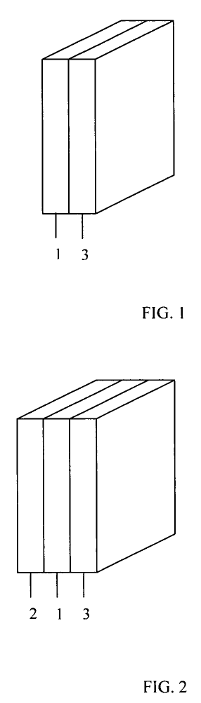

As shown in FIG. 2, a non-woven fabric substrate (1) is arranged between an outside barrier film layer (2) and an inside layer of an elastomeric material with incorporated phase change material (3). In this arrangement the elastomeric material with incorporated phase change material (3) might replace an inside barrier film layer (2).

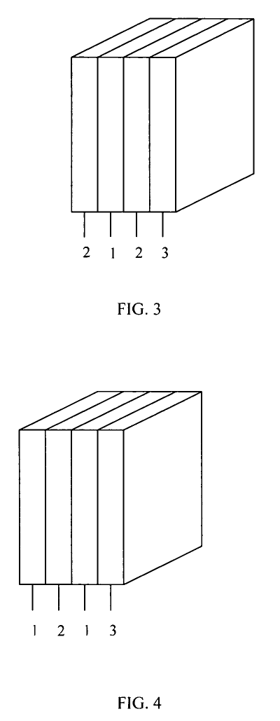

FIG. 3 illustrates a four layer arrangement where the non-woven fabric substrate (1) is arranged between two barrier films (2) and the elastomeric material with incorporated phase change material (3) is attached to the inner barrier film (2) facing to the wearer's body.

Referring to FIG. 4, a configuration is shown where the barrier film (2) is arranged between two non woven fabric substrates (1) and the elastomeric material with incorporated phase change material (3) is attached to the inner non-woven fabric substrate (1) facing to the wearer's body.

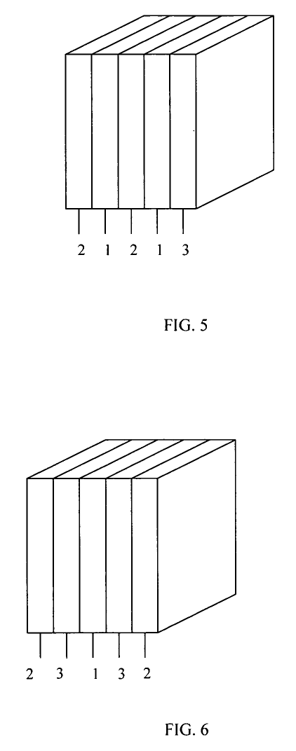

FIG. 5 shows an arrangement where the barrier film (2) which adjacent to the wearer's body of a five-layer laminate is replaced by the elastomeric material with incorporated phase change material (3).

Referring to FIG. 6 a non-woven protective garment configuration is shown where in a five-layer laminate the non-woven fabric substrate is arrange between two layers of the elastomeric material with incorporated phase change material (3) and these three layer system is covered with barrier films (2) on both sides.

A 0.3 mm thick film made of silicone rubber with 50 wt. % phase change material provides a latent heat storage capacity of about 25 kJ/m² up to 35 kJ/m². Considering a surface area of a non-woven protective suit of about 1.7 m² the requirement of a total latent heat storage capacity between 40 kJ and 60 kJ can be fulfiled.

In order to determine the improvement in the thermophysiological wearing comfort resulting from the phase change material application in a selected non-woven protective suit, controlled wearing trials have been performed. The wearing trials have been carried out in a climatic chamber under an ambient temperature of 21° C. and a relative humidity of 40%. The tests were performed by riding an bicycle-ergometer over a period of 60 minutes without interruption.

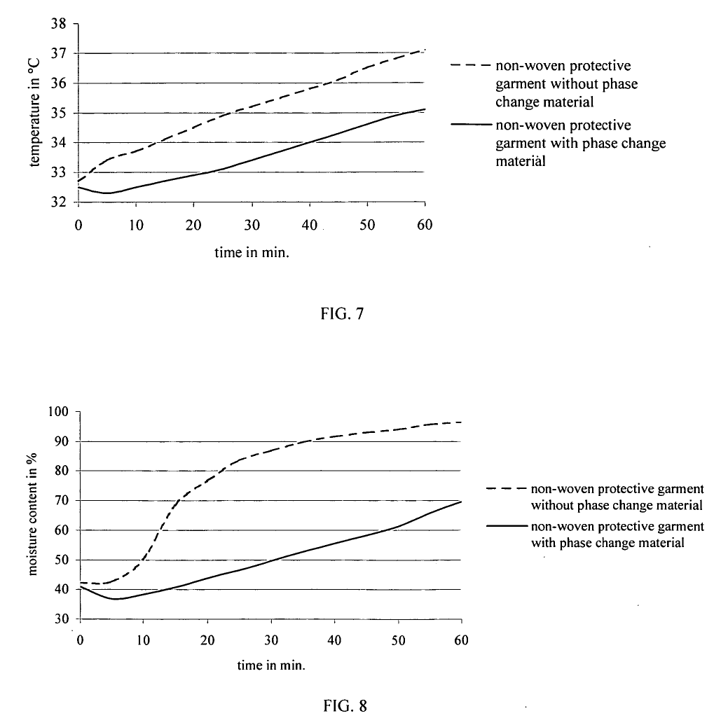

During this specific activity, a metabolic heat rate of about 18 kJ/min. was generated by the wearer's body. During the tests, the test subject wore the non-woven protective suit in conjunction with an underwear and a light work suit. Skin temperatures and moisture contents in the microclimate were recorded on several measuring points. The mean skin temperature and the average moisture content were calculated from the measurements. FIG. 7 shows the development of the mean skin temperature during the test.

The test results shown in FIG. 7 indicate that there is a fast increase in the mean skin temperature when wearing an ordinary non-woven protective suit without phase change material. After 45 minutes, the mean skin temperature already exceeds 36° C. At this point, a heat stress situation can be considered. On the other side, the cooling effect by latent heat absorption of the phase change material leads to a substantial delay in the temperature increase while wearing the non-woven protective suit with incorporated phase change material under the same conditions. At the end of the test, the difference in the mean skin temperature totals 2° C. The delay in the temperature decrease results in a significantly smaller amount of moisture build up in the microclimate such as it is shown in FIG. 8.

In an ordinary non-woven protective suit, the moisture content in the microclimate rises substantially due to the lack in moisture transfer through the composite barrier fabric system the suit consists of. Already after 15 minutes, the moisture build up in the microclimate leads to a feeling of an uncomfortable dampness. In contrast, the delayed increase in the mean skin temperature by the latent heat absorption of the phase change material results in a substantially lower amount of moisture generated by the skin. Therefore, the moisture content of the microclimate is kept on a much lower level throughout the test. Thus, the phase change material application in the selected non-woven protective suit leads to a significant increase in the thermo-physiological wearing comfort.

As another indicator for heat stress related reactions, the heart rate was measured continuously during the test. The test results show that the activity-related heart rate could be reduced by about 50% due to the cooling effect of the phase change material.

The test results further indicate that wearing the ordinary non-woven protective suit over a period of more than 45 minutes under the given activity level and the prevailing climatic conditions, the mean skin temperature rises to a level where heat stress is very likely. Additional tests have shown that the thermal effect provided by the phase change material can lead to substantially longer wearing times. For instance, under the described test conditions the wearing time could be doubled without a health risk. The longer wearing times without heat stress risks will result in a significant higher productivity.

What is claimed is:

1. A non-woven protective garment comprising a composite barrier fabric consisting of several layers bonded to each other having enhanced reversible thermal properties wherein at least one layer contains finely divided phase change materials.

2. A non-woven protective garment according to claim 1, wherein at least one layer of the composite barrier fabric consists of an elastomeric material.

3. A non-woven protective garment according to claim 1, wherein the layer containing the finely divided phase change materials is an elastomeric material.

4. A non-woven protective garment according to claim 1, wherein the layer which contains the finely divided phase change material is arranged on the inside of the garment.

5. A non-woven protective garment according to claim 1, wherein the layer which contains the finely divided phase change material is bonded to the non-woven fabric substrate the composite barrier fabric consists of.

6. A non-woven protective garment according to claim 1, wherein the layer which contains the finely divided phase change material is bonded to the non-woven fabric substrate the composite barrier fabric consists of replacing a barrier film layer.

7. A non-woven protective garment according to claim 1, wherein a non-woven fabric substrate is arranged between an outside barrier film layer and an inside layer of an elastomeric material with incorporated phase change material.

8. A non-woven protective garment according to claim 1, wherein a non-woven fabric substrate is arranged between an outside barrier film layer and an inside layer of an elastomeric material with incorporated phase change material which replaces a barrier film layer.

9. A non-woven protective garment according to claim 1, wherein a non-woven fabric substrate is arranged between two barrier films and the elastomeric material with incorporated phase change material is bonded to the inner barrier film adjacent to the wearer's body.

10. A non-woven protective garment according to claim 1, wherein a barrier film is arranged between two non-woven fabric substrates and the elastomeric material with incorporated phase change material is bonded to the inner non-woven fabric substrate adjacent to the wearer's body.

11. A non-woven protective garment according to claim 1, wherein the barrier film which is adjacent to the wearer's body of a five-layer laminate is replaced by the elastomeric material with incorporated phase change material.

12. A non-woven protective garment according to claim 1, wherein two layers which contain the finely divided phase change material are arranged between two outer barrier film layers and an inner non-woven fabric substrate the composite barrier fabric consists of.

13. A non-woven protective garment according to claim 1, wherein the layer which contains the finely divided phase change material is bonded to a non-woven fabric substrate of the composite barrier fabric by lamination.

14. A non-woven protective garment according to claim 1, wherein the layer which contains the finely divided phase change material is bonded to a barrier film of the composite fabric substrate by lamination.

15. A non-woven protective garment according to claim 1, wherein the layer which contains the finely divided phase change material is bonded to a non-woven fabric substrate of the composite barrier fabric by coating.

16. A non-woven protective garment according to claim 1, wherein the layer which contains the finely divided phase change material is bonded to a non-woven fabric substrate and a barrier film of the composite barrier fabric by lamination.

17. A non-woven protective garment according to claim 1, wherein the phase change material is a crystalline alkyl hydrocarbon.

18. A non-woven protective garment according to claim 1, wherein the phase change material is a salt hydrate.

19. A non-woven protective garment according to claim 1, wherein the phase change materials have melting points in the range between 20° C. and 60° C.

20. A non-woven protective garment according to claim 1, wherein the phase change materials have melting points in the range between 25° C. and 35° C.

21. A non-woven protective garment according to claim 1, possessing a latent heat storage capacity between 40 kJ and 60 kJ.
